(19) United States
(12) Patent Application Publication
(10) Pub. No.: US 2006/0101995 A1
(43) Pub. Date: May 18, 2006

(54) Treatment of chemical waste

(76) Inventor: Peter James Mawle, Bath (GB)

Correspondence Address: THE BOC GROUP, INC., 575 MOUNTAIN AVENUE, MURRAY HILL, NJ, 07974-2064, US

(21) Appl. No.: 10/541,952

(22) PCT Filed: Jan. 12, 2004
(86) PCT No.: PCT/GB04/00100

§ 371 Date: Dec. 1, 2005

(30) Foreign Application Priority Data
Jan. 14, 2003 (GB) 0300793.7
Sep. 15, 2003 (GB) 0321579.5

(51) Int. Cl. B03C 3/00

(52) U.S. Cl. 95/64

(57) ABSTRACT

A method for the treatment of gaseous chemical waste is provided. The water is continuously circulated through an essentially closed loop that incorporates a gas scrubbing unit and an ion absorption unit. The ion absorption unit comprises a water permeable ion absorbing means. The exhaust gas or a reaction product thereof is then fed to the gas scrubbing unit for dissolution in the circulating water thereby to form an aqueous solution containing ionic species derived from the exhaust gas. The circulating water is continuously brought into contact with the ion absorbing means in the ion absorption unit whilst an electrical potential is applied across the thickness of the ion absorbing means. A more concentrated aqueous solution of the ionic species is then removed from the ion absorbing means. A quantity of water corresponding to the quantity of aqueous solution of the ionic species removed from the ion absorption unit is continuously added to the closed loop.

This invention relates to the treatment of toxic and/or environmentally hazardous or harmful materials and more especially to the treatment of exhaust gases arising from various chemical processes.

The chemical processing industry in general generates vast quantities of by products and waste materials many of which represent environmental hazards and which must be neutralised or destroyed as an essential part of their ultimate disposal. The oil and gas processing industries, for example, invest heavily in plant and equipment designed specifically to prevent or minimise the release of harmful largely organic materials into the environment. The microelectronics and semi-conductor device manufacturing industries for example make similar investments in order to scrub or otherwise treat exhaust gas streams containing generally inorganic materials from chemical processing units prior to the release of those exhaust gases into the atmosphere. Compounds containing heavy metals and halogen-, sulphur-, phosphorus- and nitrogen-containing compounds can be especially toxic and their removal is the subject of a considerable amount of technical research and of much environmental protection legislation.

In many cases even dilute solutions or suspensions of such hazardous materials cannot be legally discharged. For example, the legal limit for aqueous HF discharge can be as low as 3 ppm. Nevertheless, huge quantities of not only HF but also other aqueous acids such as HCl, HNO₃ and H₂SO₄ continue to be generated by traditional scrubbing and other absorption systems. The discharge of such aqueous acids therefore involves the use of enormous quantities of fresh water to restrict acid concentration. For example, a closed loop scrubbing system for absorbing HF from an exhaust gas, operating at a recirculation rate of 25 l/min, will generally consume about 6 l/min of fresh water in order to maintain fluoride ion concentrations at an acceptably low level in the recirculating water. This discharge concentration can be as high as 4000 ppm in which case significant further dilution or treatment will be necessary.

Ion exchange techniques offer an alternative route for the capture and eventual disposal of many toxic and other hazardous materials. However, many ion exchange materials are insufficiently selective to be truly efficient. Additionally, an ion exchange material that is loaded with captured ions must be regenerated by back-washing which in turn involves the use of further potentially hazardous chemical species.

A more recent development is that of a technique known as electrochemical deionisation which is described in European Patent No. 0680932. Briefly, that technique involves the use of a combination of an electrochemical cell and an ion absorbing material in which ions captured on the absorbing material are transported through that material under the influence of an applied electric field to emerge in an eluate zone whence they are removed. That procedure appears to have a good efficiency but is described in the context of the solution to be treated making only a single pass through the electrochemical deionisation device.

The present invention seeks to provide a method which is capable of continuously removing anionic and/or cationic species from an aqueous solution circulating in a closed loop system, such as that referred to above incorporating a gas scrubbing unit, without the need for regeneration or other chemical or physical revitalisation of the separation medium.

The present invention provides in a first aspect a method for the treatment of gaseous chemical waste which comprises the steps of:

continuously circulating water through an essentially closed loop incorporating a gas scrubbing unit and an ion absorption unit comprising a water permeable ion absorbing means;

feeding exhaust gas or a reaction product thereof to the gas scrubbing unit for dissolution in the circulating water thereby to form an aqueous solution containing ionic species derived from the exhaust gas;

continuously bringing the circulating water into contact with the ion absorbing means in the ion absorption unit while applying an electrical potential across the thickness of the ion absorbing means and removing from the ion absorption unit a more concentrated aqueous solution of the ionic species; and

continuously adding to the closed loop a quantity of water corresponding to the quantity of aqueous solution of the ionic species removed from the ion absorption unit.

In one preferred embodiment the ion absorbing means may comprise a water permeable layer of an ion absorbing material and the continuously circulating water is brought into contact with one surface of the layer of ion absorbing material in the ion absorption unit and the more concentrated aqueous solution of the ionic species is removed via the other surface of the layer.

In another preferred embodiment the ion absorbing means may comprise a water permeable zone of an ion absorbing material.

The present invention provides also in a second aspect apparatus for use in carrying out such a method, comprising

an essentially closed loop circulation system containing a gas scrubbing unit and an ion absorption unit comprising a water permeable ion absorbing means and means for enabling an electrical potential to be applied across the thickness of the ion absorbing means;

a pump for continuously circulating water around the closed loop;

an inlet for exhaust gas or a reaction product thereof into the gas scrubbing unit;

an inlet for water into the closed loop circulation system; and

an outlet for a concentrated aqueous solution of ionic species from the ion absorption unit.

The apparatus may include also within the closed loop circulation system one or more heat exchangers and/or filters, hydrocyclones and similar devices to remove from the circulating solution any particulate/suspended solid matter.

In one preferred embodiment the ion absorbing means may comprise a water permeable layer of an ion absorbing material.

In another preferred embodiment the ion absorbing means may comprise a water permeable zone of an ion absorbing material.

The exhaust gas is the gaseous effluent or by-product(s) from any production procedure and the safe disposal of which or of a component of which is to be achieved. If the exhaust gas or the relevant component thereof is in a form suitable for dissolution in water and for subsequent treatment according to the method of the invention, then preliminary treatment of the exhaust gas may be unnecessary. For example, when the exhaust gas itself contains oxides of phosphorus, the gas scrubbing unit serves to effect dissolution of those oxides of phosphorus to produce aqueous phosphates and/or phosphites.

In the alternative, when the exhaust gas contains water-insoluble materials such as fluorocarbons or CFCs, it will be necessary to employ a combustor, plasma reactor or other reaction unit in order to convert those water-insoluble materials into water-soluble form. Fluorocarbons, for example, may be converted into HF in this manner, and HF dissolves readily in water in the gas scrubbing unit to generate hydrofluoric acid.

The ion absorbing materials serve to capture the ions of interest and are preferably ion exchange materials such as ion exchange resin in the form of particles or beads or other materials that can provide:

a solution permeable medium;

an ion adsorption medium (to remove the anions or cations);

an ion conducting medium whereby the ions may be moved by the imposed electrical field into a separate solution.

The particles or beads of the resin are preferably in a coherent form, that is to say they are not mobile or loose, but are constrained in a predetermined configuration. For example, the particles or beads may be bound together with a binder or held between layers of a mesh or membrane, so as to be permeable to the aqueous solution containing the ions. The electrical potential which is applied across, for example, the thickness of the layer of ion absorbing material serves to drive the captured ions through the ion absorbing material towards one or other of the electrodes through which the potential is applied. The electrical potential may be generated from a pair of electrodes arranged to form an electrolysis cell or by any alternative arrangement, for example in the form of an electrophoresis cell.

It has been found that using the method and apparatus according to the invention, it is possible to effect continuous separation of anions and/or cations within a closed loop circulation system such as that used for gas scrubbing, without any need for regenerating or periodically replacing the ion absorbing means. The efficiency of the method and apparatus will depend upon the nature of the ion absorbing means and of the ion or ions to be captured, the concentration of the ion or ions in the solution and other factors such as flow rates and electrical potential but initial indications are that ion extraction rates of up to 98% per pass can be achieved.

With such high extraction rates, the removal of acid cations such as F, SO₄²⁻ and NO₃⁻ will have a dramatic effect upon improving the service life of the equipment in the circulation system, such as pumps, meters, valves and baffles.

The method of the invention is applicable to a wide variety of cationic species such as sulphate, sulphite, nitrate, nitrite, phosphate, phosphite and halides, that is to say fluoride, chloride, bromide and iodide, as well as anionic species, especially metals and more especially heavy metals.

The invention does, however, have particular applicability to fluoride such as that generated as a by-product of the semi-conductor manufacturing industry and which produces aqueous hydrofluoric acid as a result of reaction followed by dissolution in a gas scrubbing unit.

It has unexpectedly been found that the ions stripped from the aqueous solution do not re-enter the aqueous circulation stream that continues to flow, for example, across the surface of the ion absorbing material. Although the gas scrubbing operation will generally be carried out on a continuous basis, the acid content of the gas entering the scrubber may be variable and may often be totally absent. This means that the fluoride ion content of the water passing across the surface of the ion absorbing material is correspondingly variable. The fact that the captured ions are transported away from the surface of the ion absorbing material under the influence of the applied electrical potential removes those ions from being resolubilised by the water. This represents a significant improvement in ion absorption efficiency.

Compared to the example given above of a closed loop gas scrubbing system resulting in aqueous HF operating at a recirculation rate of 25 l/min and consuming about 6 l/min fresh water, a similar system incorporating the features of the present invention has been shown in initial trials to be capable of achieving up to a 30-fold reduction in the fresh water requirement.

The invention is described below in greater detail by way of example only with reference to the accompanying drawings, in which:

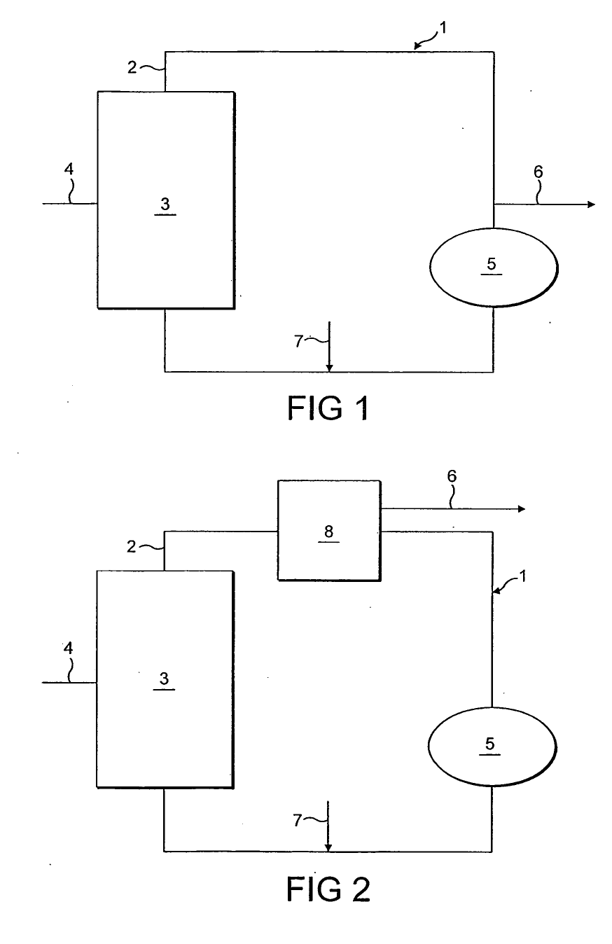

FIG. 1 is a schematic representation of a closed loop recirculation gas treatment apparatus known from the prior art;

FIG. 2 is a schematic representation of a closed loop recirculation gas treatment apparatus according to the invention;

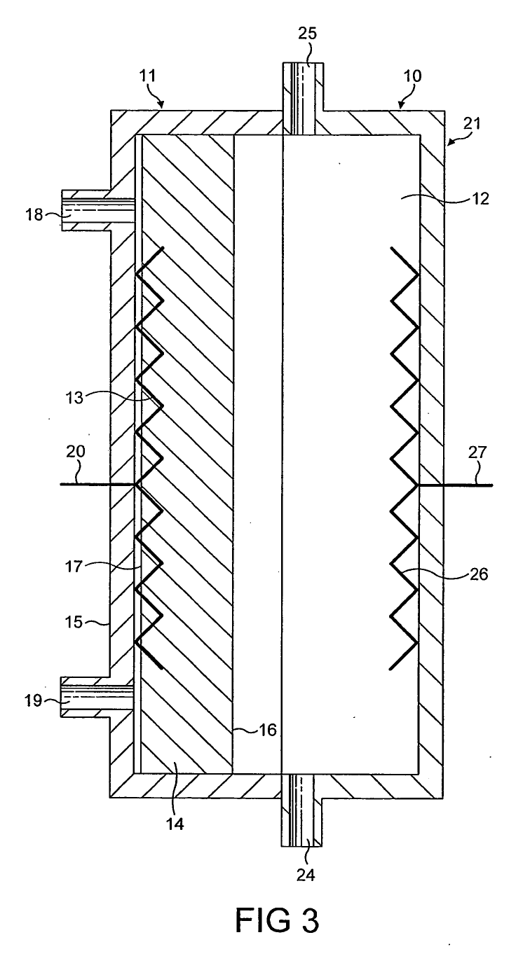

FIG. 3 is a schematic representation of an example of an electrochemical cell which may be used in the apparatus shown in FIG. 2; and

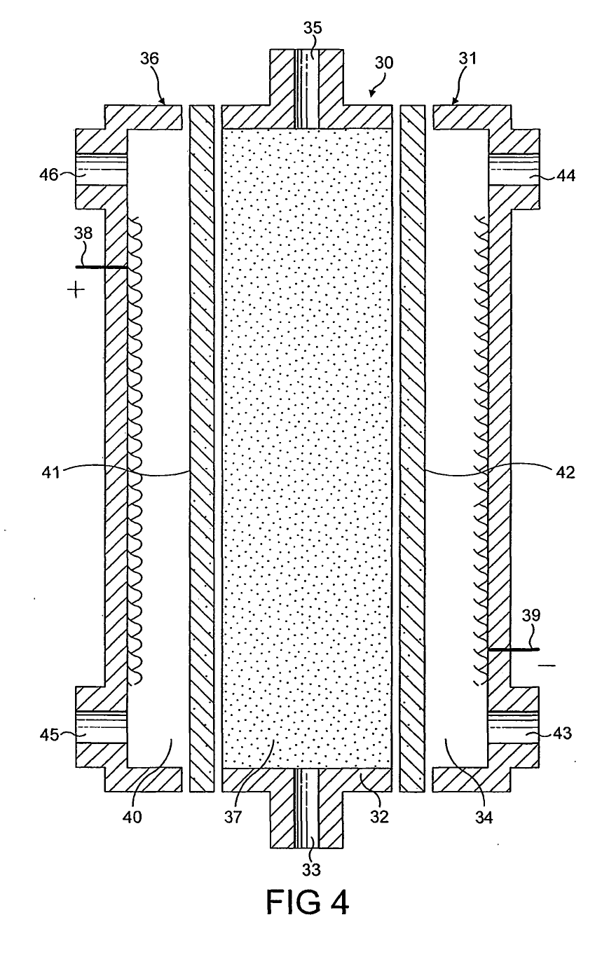

FIG. 4 is a schematic representation of a further example of an electrochemical cell which may be used in the apparatus shown in FIG. 2.

Referring to the drawings, in FIG. 1 there is shown a schematic representation of a conventional gas treatment unit for exhaust gases from a semi-conductor device manufacturing plant. The exhaust gases may contain many and varied species including halogen-, phosphorus-, silicon- and boron-containing compounds. The exhaust gases or the products of their preliminary reaction, for example HF in the case of fluorine-containing compounds, enter the gas scrubbing unit 3 through line 4 where they are brought into intimate contact with water entering through line 2. Line 2 forms part of a closed loop circulation system 1 which includes a pump 5 for the forced circulation of water around the loop, together with a line 6 through which aqueous HF can be drained from the system and a line 7 through which corresponding amounts of fresh water may be admitted to the loop. The circulation system 1 may also include one or more other conventional items, for example filters, hydrocyclones, heat exchangers, meters, gauges and valves. The gas scrubbing unit 3 will contain packing, baffles, cyclones and/or similar means, to optimise liquid/gas surface contact in order to promote dissolution of gas in the aqueous liquid; such scrubbing technology is well known in the art and does not need to be separately described here.

In an example of conventional operation, 200 slpm of an exhaust gas containing 2,000 sccm C₂F₆ is stoichiometrically converted into HF (12,000 sccm HF) which enters the gas scrubbing unit 3 through line 4 and contacts water entering through line 2 at a rate of 25 l/min and is dissolved in that water. Up to 400 ppm HF will usually be dissolved in the aqueous stream in this way although concentrations as high as 4000 ppm HF can be achieved by higher input gas flows and prolonged recirculation of the liquid. Undissolved gas is typically discharged from the scrubber to the atmosphere. Fresh water is admitted to the loop through line 7 at a rate of 6 l/min and aqueous acid is withdrawn through line 6 at a corresponding rate. The withdrawn acid will have a HF content dependent upon gas input and will present serious problems of disposal.

Referring now to FIG. 2, the system shown is in accordance with the invention and is generally similar to that shown in FIG. 1 in that the closed loop 1 includes a gas scrubbing unit 3 and a pump 5. In this case, however, the loop incorporates also an acid removal unit 8. An example of a suitable acid removal unit is described in greater detail below but in trials it has been shown to be capable of generating 0.1-0.2 l/min (approximately 200 l/day) aqueous 0.7-1.2M HF from a continuous input at 25 slpm of 400-500 ppm HF giving a continuous liquid output of 10-30 ppm HF. As a consequence, the aqueous liquid entering the gas scrubbing unit contains much less dissolved HF, thereby rendering HF absorption in the gas scrubbing unit more efficient. Also, the HF concentration in the circulating liquid in the loop can be maintained at a lower level than hitherto, thereby improving the service life of the equipment. Moreover, the reduced volume of generated material, in this case 0.7-1.2 M hydrofluoric acid is usable as such and its disposal does not therefore present a problem.

Turning now to FIG. 3 of the drawings, there is shown an example of an electrochemical cell suitable for incorporation into the closed loop of the apparatus shown in FIG. 2, for separating HF from the circulating acid solution. The cell is in fact very similar to that described in European Patent No. 0680932, referred to above.

The electrochemical cell 10 shown in FIG. 3 of the drawings comprises an electrode assembly 11 and a housing 21 which together define a compartment 12. The electrode assembly 11 comprises a current feeder 13 in contact with an electrode contact 20 and is embedded in a permeable layer 14 of particulate ion exchange resin bound together with a binder within a housing 15 and presenting front and rear surfaces 16 and 17. The rear surface 17 is adjacent but slightly spaced from a wall of the housing 15 which in turn includes a vent 18 and an elution port 19. The housing 21 includes an inlet 24 and an outlet 25 for the circulating aqueous liquid and includes a counter electrode 26 in contact with an electrode contact 27.

In order to remove fluoride and nitrate ions from the circulating liquid in the closed loop system, the permeable layer 14 will include a weak anion exchange resin. The circulating solution of fluoride and nitrate passes through compartment 12 via the inlet 24 and outlet 25 and within the cell it contacts the front surface 16 of the ion exchange layer 14 and the counter electrode 26. An electric potential between the feeder 13 (anode) and the counter electrode 26 (cathode) generates H⁺ at the feeder 13. Those hydrogen ions move towards the counter electrode 26 and interact with and activate the anion exchange resin in the layer 14. The fluoride and nitrate ions in the solution move into the layer 14 where they are adsorbed onto the activated ion exchange resin and in which they move under the influence of the applied potential towards the rear surface 17. This enables more fluoride and nitrate ions to be adsorbed at the front surface 14 to permit continuous removal of those ions from the aqueous solution circulating through cell 10. Water from the solution also permeates the layer 14 and flows towards the rear surface 17 whence it and the captured fluoride and nitrate ions collect to be removed through the elution port 19 as aqueous hydrofluoric/nitric acid.

FIG. 4 illustrates an alternative example of an electrochemical cell that may be incorporated into the closed loop of the apparatus shown in FIG. 2. The electrochemical cell 30 shown in FIG. 4 comprises an electrode assembly 36 and an electrode assembly 31 spaced apart by a dividing section 32 which incorporates an inlet port 33 and an outlet port 35 for aqueous solution. The electrode assemblies 36 and 31 and dividing section 32 together define a solution compartment 37.

The electrode assemblies are separated from the solution compartment by suitable ion permeable membranes, 41 and 42 that allow cations to move into a cathode compartment 34 and anions to move into an anode compartment 40. The anode compartment 40 contains an anode 41 and the cathode compartment 34 contains a cathode 39.

Catholyte solution can be introduced and removed from the cathode compartment 34, through ports 43 and 44 and anolyte solution can be introduced and removed from the anode compartment 40, through ports 45 and 46. The solution compartment 37 is filled with suitable ion exchange material for the anions and cations to be adsorbed.

In the case of aqueous solutions of fluoride or other anions e.g. nitrate passing through the compartment 37 via inlet 33 and outlet 35 within the cell these ions are adsorbed onto the resin. An electrical potential between the electrodes 38 and 39 causes fluoride or other anions adsorbed on the resin to pass through the ion exchange layer to membrane 41 and through that membrane into the anode compartment 40, generating concentrated fluoride or other anion solutions in the anode compartment. The input aqueous solution depleted in fluoride or other anions flows out of the cell through outlet port 35.

It will be understood that this alternative example of an ion adsorption unit consisting of ion exchange material is, in operation, self-regenerating in that it effectively transports the captured cations and/or anions through its bulk for discharge as a concentrated aqueous solution, and will regenerate to its hydrogen or hydroxide form when no other cationic or anionic species is present. Such an electrically regenerating ion exchange unit is known as an ERIX unit. Such units may comprise many ion removal and concentration channels in parallel and will be known to those skilled in the art.

1. A method for the treatment of gaseous chemical waste which comprises the steps of:
continuously circulating water through an essentially closed loop incorporating a gas scrubbing unit and an ion absorption unit comprising a water permeable ion absorbing means;
feeding exhaust gas or a reaction product thereof to the gas scrubbing unit for dissolution in the circulating water thereby to form an aqueous solution containing ionic species derived from the exhaust gas;
continuously bringing the circulating water into contact with the ion absorbing means in the ion absorption unit while applying an electrical potential across the thickness of the ion absorbing means and removing from the ion absorption unit a more concentrated aqueous solution of the ionic species; and
continuously adding to the closed loop a quantity of water corresponding to the quantity of aqueous solution of the ionic species removed from the ion absorption unit.

2. A method according to claim 1, wherein the ion absorbing means comprises a water permeable layer of an ion absorbing material.

3. A method according to claim 2, wherein the continuously circulating water is brought into contact with one surface of the layer of ion absorbing material in the ion absorption unit and the more concentrated aqueous solution of the ionic species is removed via the other surface of the layer.

4. A method according to claim 1, wherein the ion absorbing means comprises a water permeable zone of an ion absorbing material.

5. A method according to claim 1, wherein the exhaust gas or the reaction product thereof is fed continuously to the gas scrubbing unit.

6. A method according to claims 1, wherein the exhaust gas or the reaction product thereof is fed intermittently to the gas scrubbing unit.

7. A method according to claim 1, wherein the exhaust gas or the reaction product thereof contains HF and the ionic species is F−.

8. A method according to claim 1, wherein the exhaust gas or the reaction product thereof contains HCl and the ionic species is Cl⁻.

9. A method according to claim 1, wherein the exhaust gas or the reaction product thereof contains oxides of nitrogen and the ionic species is NO₃.

10. A method according to claim 1, wherein the exhaust gas or the reaction product thereof contains oxides of sulfur and the ionic species is SO₄²⁻.

11. A method according to any claim 1, wherein the exhaust gas or the reaction product thereof contains oxides of phosphorus and the ionic species is PO₄³⁻.

12. An apparatus for treating gaseous chemical waste comprising:
an essentially closed loop circulation system containing a gas scrubbing unit and an ion absorption unit comprising a water permeable ion absorbing means and means for enabling an electrical potential to be applied across the thickness of the ion absorbing means;
a pump for continuously circulating water around the closed loop;
an inlet for exhaust gas or a reaction product thereof into the gas scrubbing unit;
an inlet for water into the closed loop circulation system; and
an outlet for concentrated aqueous solution of ionic species from the ion absorption unit.

13. Apparatus according to claim 12, wherein the ion absorbing means comprises a water permeable layer of an ion absorbing material.

14. Apparatus according to claim 12, wherein the ion absorbing means comprises a water permeable zone of an ion absorbing material.

15. Apparatus according to any of claims 12, which comprises also within the closed loop circulation system a heat exchangers.

16. Apparatus according to claim 12, which comprises also within the closed loop circulation system a filter.

17. Apparatus according to claim 12, which comprises also within the closed loop circulation system a hydrocyclone.
